(19) United States
(12) Patent Application Publication
(10) Pub. No.: US 2004/0162207 A1
(43) Pub. Date: Aug. 19, 2004

(54) Apparatus for erecting flattened box blanks

(75) Inventors: Reinhold Ruf, Laupheim (DE); Jochen Stohr, Ingerkingen (DE); Achim Gotz, Winnenden (DE); Klaus-Ulrich Kollner, Weissach i. T. (DE); Helmut Pless, Welzheim (DE); Edgar Wieland, Winnenden-Birkmannsweiler (DE)

Correspondence Address: THE FIRM OF KARL F ROSS, 5676 RIVERDALE AVENUE, PO BOX 900, RIVERDALE (BRONX), NY, 10471-0900, US

(73) Assignee: UHLMANN Pac-Systeme GmbH & Co. KG

(21) Appl. No.: 10/668,110

(22) Filed: Sep. 22, 2003

(30) Foreign Application Priority Data
Sep. 23, 2002 (DE) 10244103.0

(51) Int. Cl. B31B 1/78

(52) U.S. Cl. 493/309

(57) ABSTRACT

A box-erecting apparatus has a supply holding a stack of flattened blanks, an erecting station spaced in a transport direction from the supply and provided with a plunger and elements for erecting a flattened blank into an upwardly open box, and a support between the supply and the station positioned to receive a flattened blank. An inner arm between the supply and the station has an inner end pivoted about an inner axis transverse to the direction and an outer end, and an outer arm has an inner end pivoted on the inner-arm outer end about an outer axis generally parallel to the inner axis and an outer end carrying a grab. A drive can pivot the arms independently of each other about the respective axes between a position with the grab engaging one of the blanks in the support and a position depositing one of the blanks on the support.

### FIELD OF THE INVENTION

The present invention relates to an apparatus for erecting flattened box blanks. More particularly this invention concerns such an apparatus which picks the blanks out of a supply stack, erects them, and sets them onto a conveyor.

### BACKGROUND OF THE INVENTION

Boxes are typically supplied to the user as a stack of flattened blanks that must be erected prior to filling. This is typically done by a machine which pulls the blanks one at a time out of a supply holding the stack of flattened blanks, erects it by interaction with other elements, and then sets it on a conveyor for use. Typically the box is erected on its side, that is opening laterally so it must be turned before it can be filled. See German 2,060,952 of Leonhardt, EP 1,184,161 of Mohrbach, French 2,166,749, U.S. Pat. No. 4,028,999 of Lee, and U.S. Pat. No. 4,988,331 of Boisseau.

A significant problem with such an apparatus is that it must be able to work with boxes of different sizes. To this end it is standard to provide a relatively large spacing between the plunger system used to erect the boxes and the end of th supply holding the stack of flattened blanks. This long distance is needed in order to be able to swing a blank of maximum size through an arc as it is moved from the supply to the erecting station.

### OBJECTS OF THE INVENTION

It is therefore an object of the present invention to provide an improved apparatus for picking and erecting flattened box blanks.

Another object is the provision of such an improved apparatus for picking and erecting flattened box blanks which overcomes the above-given disadvantages, that is which can handle blanks of different sizes but which is nonetheless fairly small.

### SUMMARY OF THE INVENTION

A box-erecting apparatus has a supply holding a stack of flattened blanks, an erecting station spaced in a transport direction from the supply and provided with a plunger and elements for erecting a flattened blank into an upwardly open box, and a support between the supply and the station positioned to receive a flattened blank. According to the invention an inner arm between the supply and the station has an inner end pivoted about an inner axis transverse to the direction and an outer end, and an outer arm has an inner end pivoted on the inner-arm outer end about an outer axis generally parallel to the inner axis and an outer end carrying a grab. A drive can pivot the arms independently of each other about the respective axes between a position with the grab engaging one of the blanks in the support and a position depositing one of the blanks on the support.

This arrangement is advantageous in that its overall length does not change with blank format. A large blank can be pivoted virtually in place by the two-arm system while a small blank can be pivoted and shifted in the transport direction. More particularly, when the blank is large, the inner arm pivots only through a small angle, while the outer arm pivots through a large one. With a small blank, the outer arm pivots through a considerable angle and the outer arm through a small angle. Either way the blank is typically shifted from a basically upright position, that is lying in a generally vertical plane, to a horizontal position lying on the support/conveyor.

According to the invention the drive includes respective independently operable drives connected to the arms. Typically independent servomotors connected to a computer-type controller are employed.

The inner and outer axes are horizontal and the direction is horizontal according to a further feature of the invention. Thus a stack of the blanks is loaded into the supply, with the blanks on edge, whereas upwardly open erected boxes exit the downstream end of the machine.

The support according to the invention is horizontally displaceable in the transport direction. It can be formed by horizontally reciprocal rails whose horizontal spacing transverse to the transport direction is adjustable to accommodate different blank sizes. The inner arm moves between the two rails of the support, which acts as a conveyor.

The supply and inner axes are horizontally displaceable on the apparatus. Thus the system can easily be adjusted for blanks of different sizes, although a wide range can be accommodated simply by changing the pivot angles of the two arms. A system for applying glue to flaps of the blank is associated with the support so that, before the blank is delivered to the plunger for formation into a box, its flaps are provided with glue strips ready for adhering to each other.

The plunger is vertically adjustable so that, with a short box, that is one with a small vertical dimension, it does not have to be retracted too far into its upper position between box-forming cycles. In any case this upper position is adjustable. This cycling time for short boxes can be minimized.

The erecting station includes elements engageable with flaps of the blank and forming an upwardly open die that is also openable in the transport direction. The upwardly open box is dropped into a cell of a conveyor so that it can be transported off easily. Such a cell has adjustable leading and trailing elements that ensure that the freshly made box is accurately held and positioned as it is moved off.

### BRIEF DESCRIPTION OF THE DRAWING

The above and other objects, features, and advantages will become more readily apparent from the following description, reference being made to the accompanying drawing in which:

FIGS. 1 to 4 show the apparatus according to the invention in successive stages of picking and erecting a large-size blank;

FIGS. 5 to 8 are views like respective FIGS. 1 to 4 but with a small blank; and

FIG. 9 is a perspective view of a detail of the machine.

### SPECIFIC DESCRIPTION

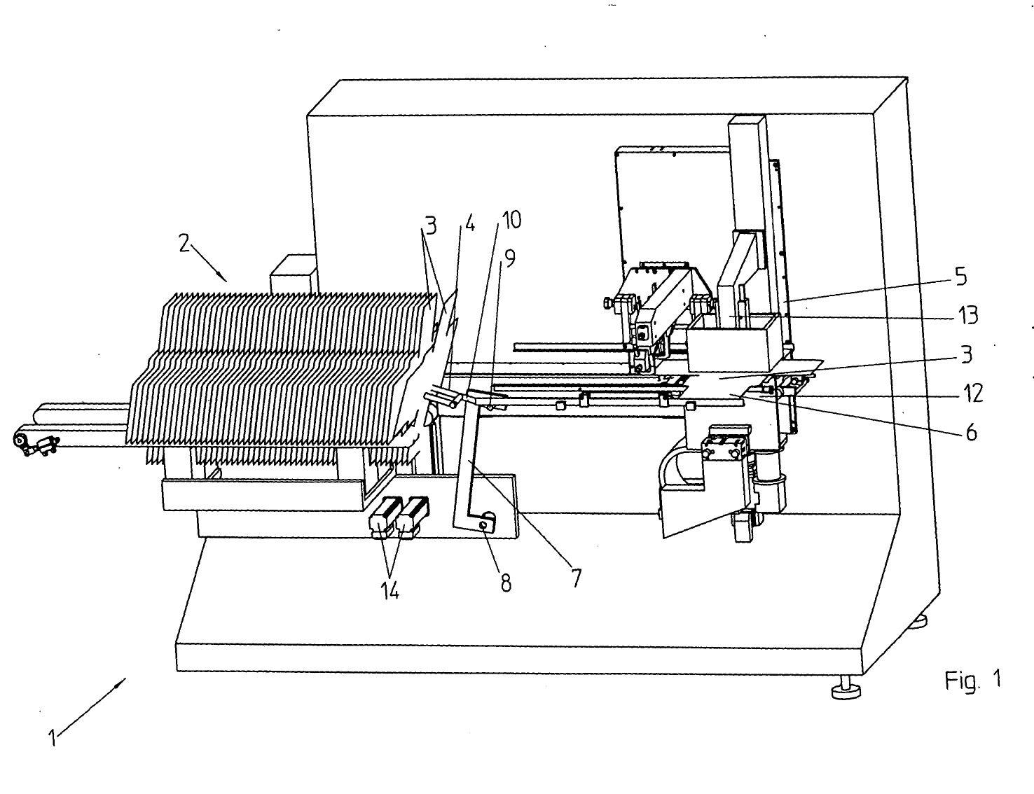

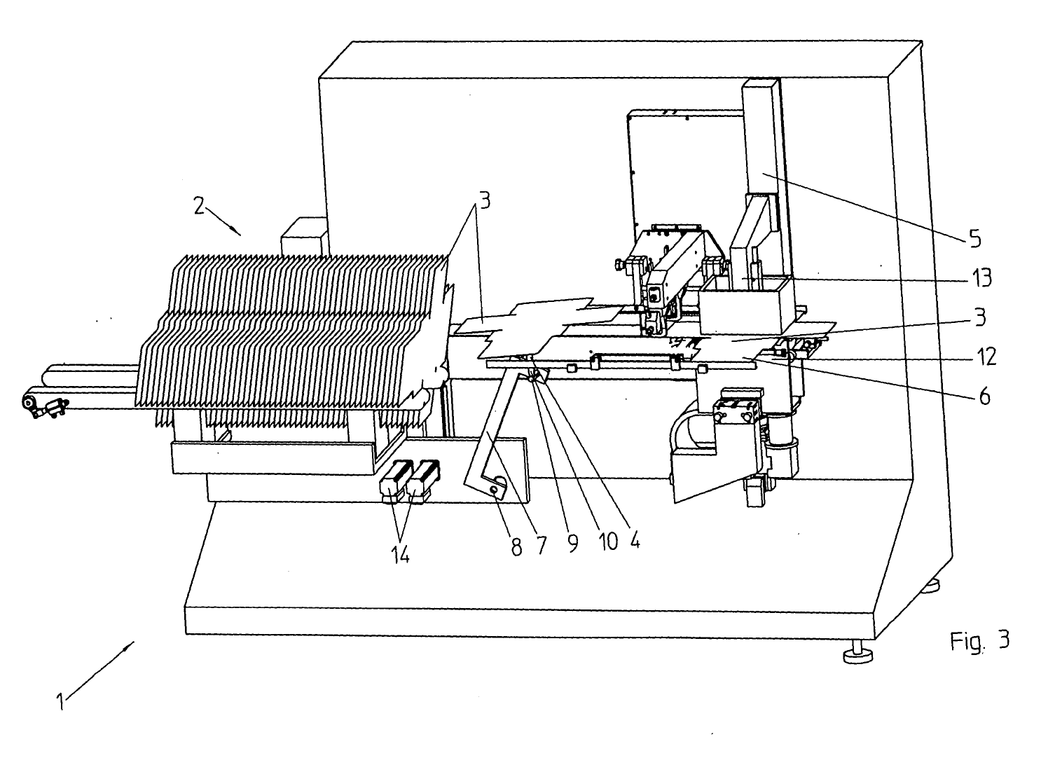

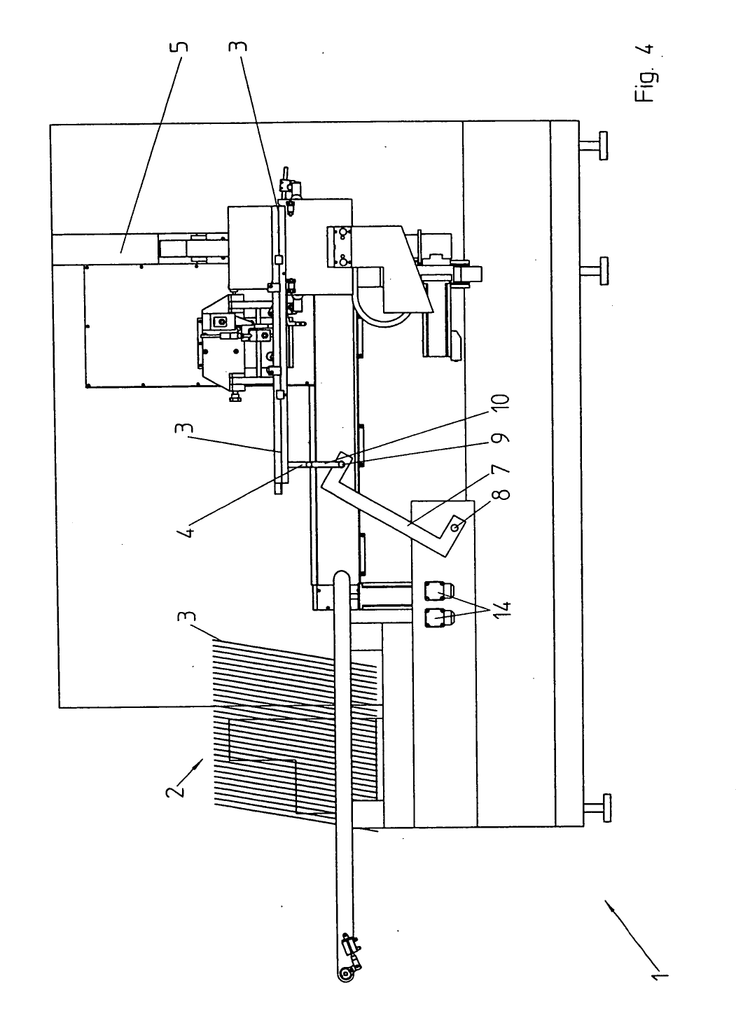

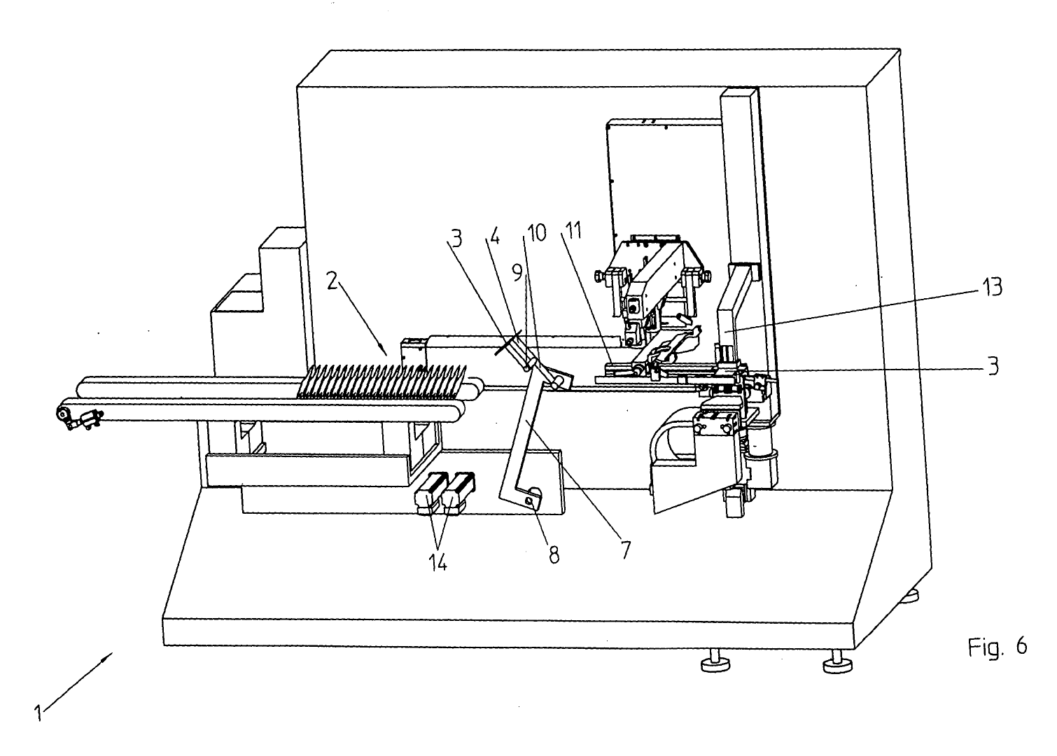

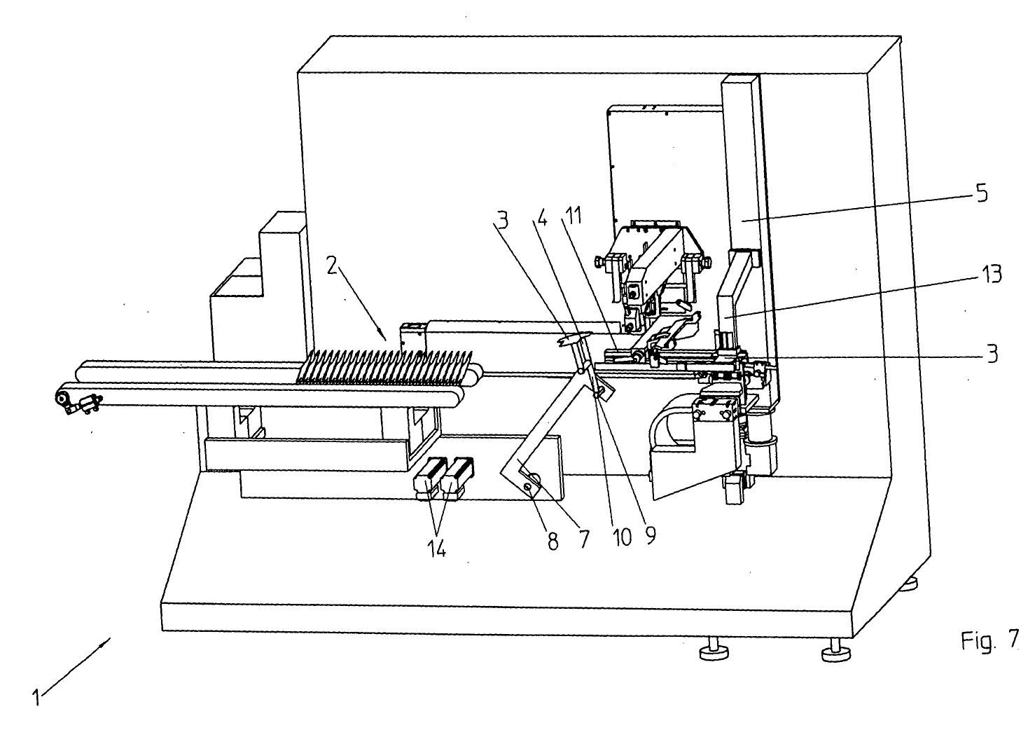

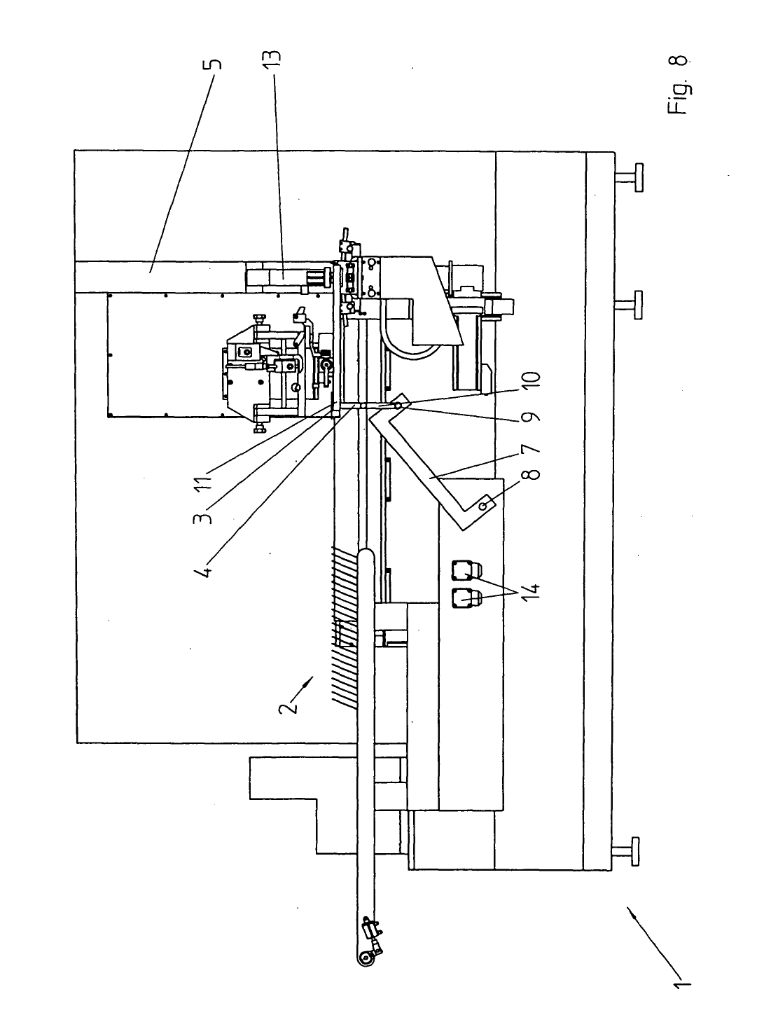

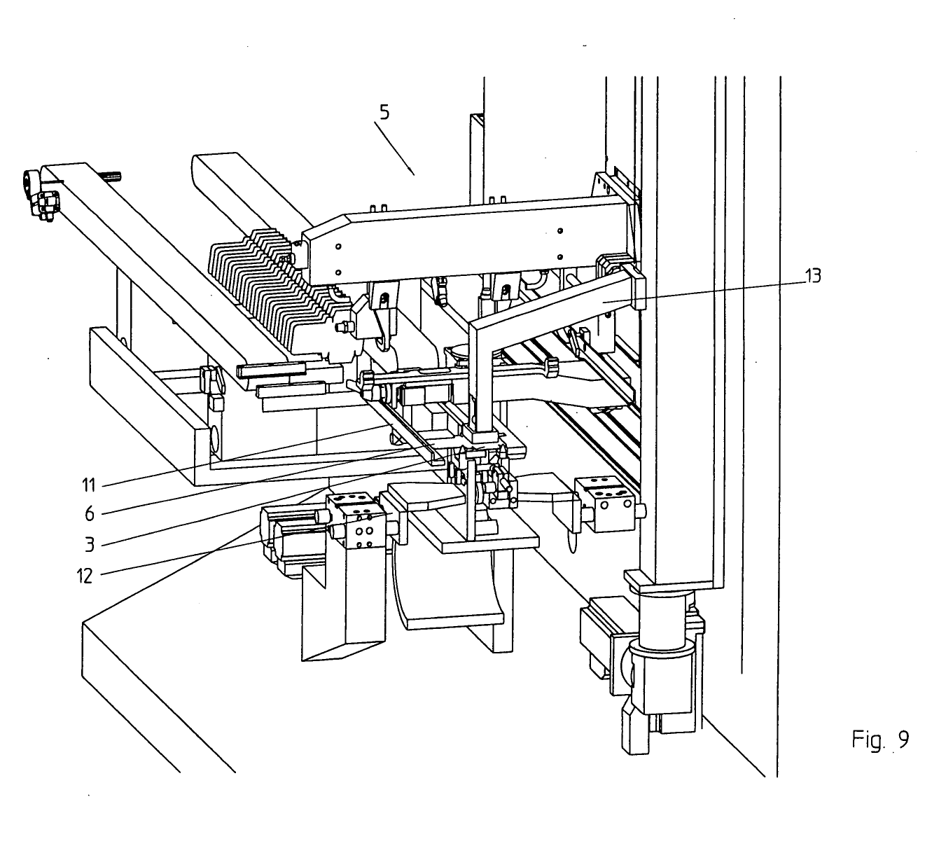

As seen in FIGS. 1-9 an apparatus 1 according to the invention has a supply 2 holding a stack of flattened box blanks 3 standing on edge, that is lying in upright planes. A suction-type grab 4 is carried on an outer end of an outer arm 10 whose inner end is pivoted about a horizontal axis 9 on an outer end of a C-shaped inner arm 7 whose inner end in turn is pivoted on the machine 1 about another horizontal axis 8 parallel to the axis 9 and perpendicular to a transport direction D. Respective drives 14 are connected to the arms 7 and 10 for pivoting them independently of each other about their axes 8 and 9.

Extending in the transport direction D downstream from the supply and from a location above the axis 8 is a horizontally reciprocal conveyor/support 11 formed by a pair of horizontal rails parallel to the direction D. The vertical position of the support 11 can be changed according to the size of the blank 3 reciprocation of the support 11 in the direction D displaces a blank 3 it is carrying in this direction D. At the downstream end of the rails forming the support 11 is an erecting station 5 formed by a plunger 13 mounted on a vertically effective actuator and elements 12 that serve to fold up side flaps 6 of the blanks 3.

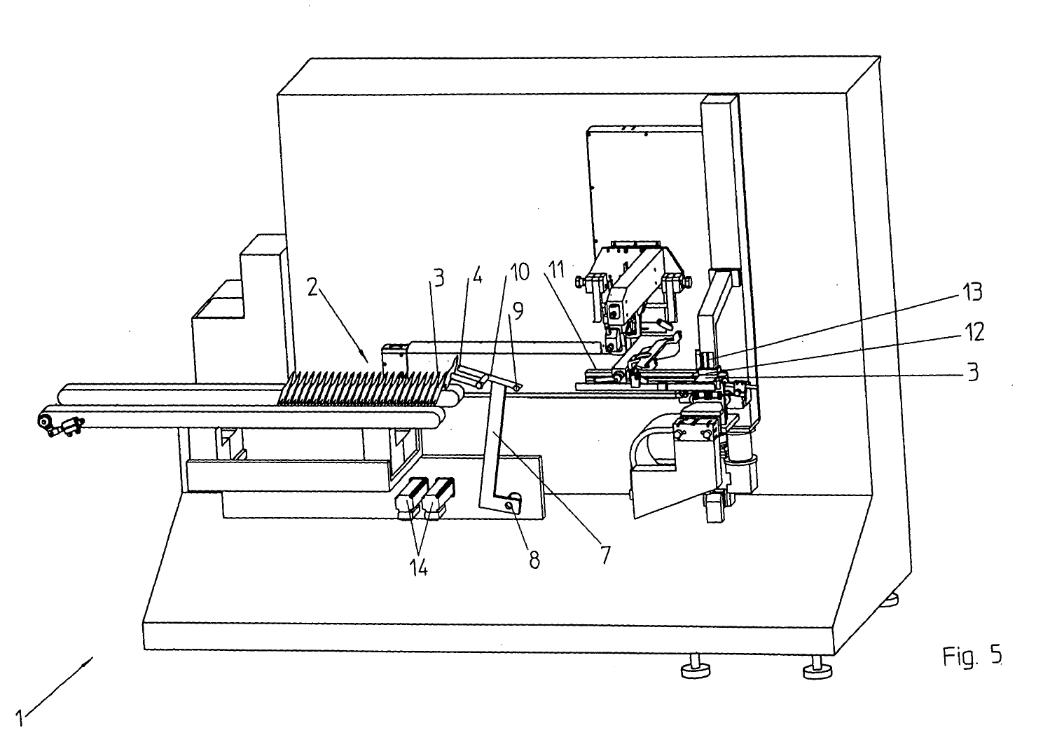

Thus, as can be seen by a comparison of FIGS. 1-4 with respective FIGS. 5-8, when a large-format blank 3 (FIGS. 1-4) is being worked on, the rails forming the support 11 are spread somewhat widely horizontally and transversely to the direction D and are extended downstream whereas for a small-format blank 3 (FIGS. 5-8) they are more closely spaced and not extended far downstream from the erecting station 5. The starting position (FIGS. 1 and 5) for both blanks 3 is the same, with the arm 7 generally vertical and the arm 10 generally horizontal and the grab 4 pressed against the end blank 3 in the supply.

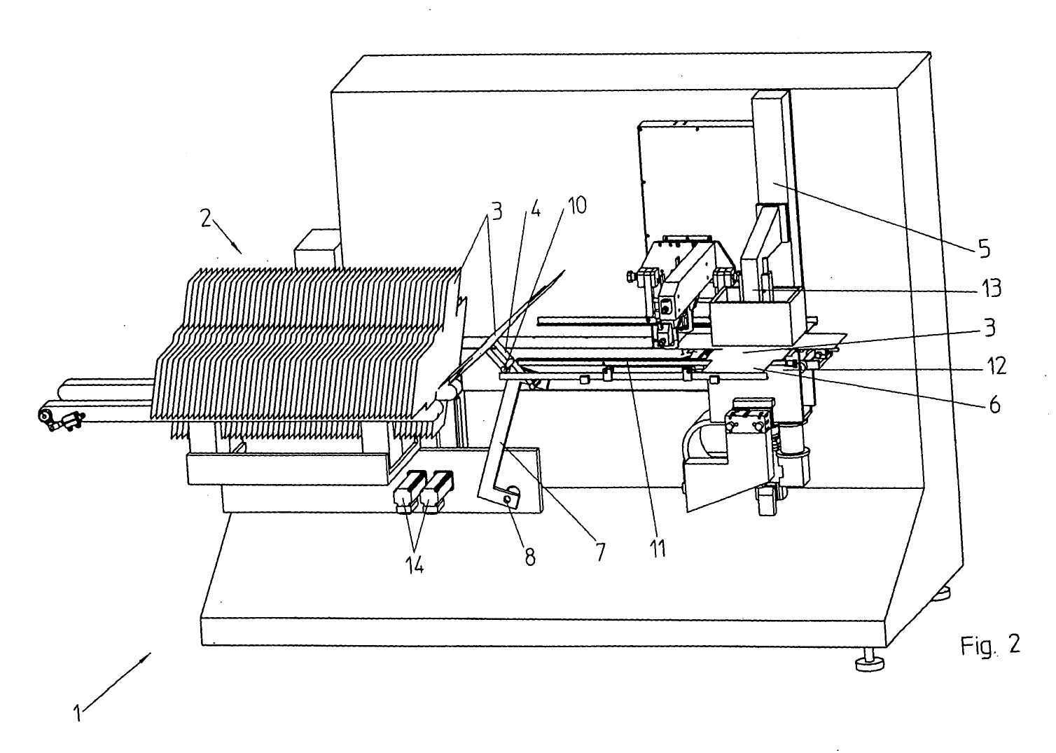

Then the arm 7 is pivoted through a relatively small arc for a large blank 3 as shown in FIGS. 2-4, while for the small blank as shown in FIGS. 5-8, it is pivoted through a much larger arc. On the contrary, the arm 10 is pivoted about the pivot 9 on the arm 7 through a large arc for the large blank 3 and a small arc for a small blank 3, ending up in an upwardly directed horizontal position in both setups.

Thus with the system of this invention, one need only provide enough room between the supply 2 and the erecting station 5 to pivot the largest possible blank through about 90°. When a smaller blank is used, it is not only pivoted but also swung through a large arc. Thus the support 11 need only move through a relatively short stroke with a small blank 1 and the plunger 13 need only make a short vertical stroke to form an upwardly open box, and to pull out of it so it can be transported away from the station 5.

We claim:

1. A box-erecting apparatus comprising:
a supply holding a stack of flattened blanks;
an erecting station spaced in a transport direction from the supply and provided with means including a plunger for erecting a flattened blank into an upwardly open box;
a support between the supply and the station positioned to receive a flattened blank;
an inner arm between the supply and the station and having an inner end pivoted about an inner axis transverse to the direction and an outer end;
an outer arm having an inner end pivoted on the inner-arm outer end about an outer axis generally parallel to the inner axis and an outer end;
a grab on the outer-arm outer end; and
drive means for pivoting the arms about the respective axes between a position with the grab engaging one of the blanks in the support and a position depositing one of the blanks on the support.

2. The box-erecting apparatus defined in claim 1 wherein the drive means includes respective ind pendently operable drives connected to the arms.

3. The box-erecting apparatus defined in claim 2 wherein the inner and outer axes are horizontal and the direction is horizontal.

4. The box-erecting apparatus defined in claim 3 wherein the support is horizontally displaceable in the transport direction.

5. The box-erecting apparatus defined in claim 3 wherein the supply and inner axes are horizontally displaceable on the apparatus.

6. The box-erecting apparatus defined in claim 3 wherein the plunger is vertically adjustable.

7. The box-erecting apparatus defined in claim 6 wherein the plunger is vertically shiftable between an upper position and a lower position and the upper position is adjustable.

8. The box-erecting apparatus defined in claim 1 wherein the erecting station includes elements engageable with flaps of the blank.

9. The box-erecting apparatus defined in claim 8 wherein the elements form an upwardly open die that is openable in the transport direction.
